(19) United States
(12) Patent Application Publication
(10) Pub. No.: US 2026/0011460 A1
(43) Pub. Date: Jan. 8, 2026

(54) SYSTEMS AND METHODS FOR DECAY HEAT REMOVAL FROM AN EXTERIOR OF A NUCLEAR REACTOR

(71) Applicant: GE-Hitachi Nuclear Energy Americas LLC, Wilmington, NC (US)

(72) Inventors: Derek Bass, Wilmington, NC (US); Randy R. Ford, Dayton, TN (US)

(21) Appl. No.: 18/765,261

(22) Filed: Jul. 6, 2024

(51) Int. Cl. G21C 15/12; G21C 15/243; G21C 15/28

(52) U.S. Cl. CPC G21C 15/12; G21C 15/243; G21C 15/28

(57) ABSTRACT

Fill systems introduce coolant against nuclear reactor exteriors to transfer heat away from the reactor. Coolant is stored inside or outside a containment and allowed to fill the same up to the reactor with a proper amount of coolant. Natural, artificial, fuel pool, underground, and other sources and flows of coolant may be used. Valves or other flow control structures allow an operator or automated plant control systems to determine when and how much the coolant fills around the reactor. Other systems are not blocked by the filling coolant. Thermally-blocking materials or structures can be included as an exterior of reactor to limit risks in temperature difference between the coolant and pressure vessel. Fill systems may be implemented at plant construction or as a retrofit. Other safety systems such as an RVACS may be relieved by the fill systems and differently operated, such as with active systems and security barriers.

### BACKGROUND

FIG. 1 is a profile cross-section of a related art liquid metal nuclear reactor, such as that described in co-owned U.S. Pat. No. 5,406,602 to Hunsbedt et al. issued Apr. 11, 1995, incorporated herein in its entirety by reference. As seen in FIG. 1, annular or circular concrete silo 8, potentially underground, houses annular guard vessel 2 that in turn houses reactor 1, potentially all concentrically aligned. Reactor 1 includes a nuclear reactor core 12 submerged in a liquid metal coolant, such as liquid sodium. A space, shown as gap 3, between reactor 1 and guard vessel 2 may be filled with an inert gas, such as argon. Reactor 1 and guard vessel 2 are suspended vertically downward from upper frame 16. Concrete silo 8 may support upper frame 16 by seismic isolators 18 to maintain structural integrity of guard vessel 2 and reactor 1 during earthquakes and allow uncoupled movement between those structures and surrounding silo 8.

Reactor 1 is controlled by neutron-absorbing control rods 15 selectively inserted into or withdrawn from reactor core 12. Reactor 1 may be shut down entirely for responding to an emergency condition or performing routine maintenance by inserting control rods 15 into core 12 of fissionable fuel to deprive the fuel of the needed fission-producing neutrons. However, residual decay heat continues to be generated from core 12 decreasing exponentially over time. This heat must be dissipated from shut-down reactor 1. The heat capacity of the liquid metal coolant and adjacent reactor structures aid in dissipating the residual heat. For instance, heat may be transferred by thermal radiation from reactor 1 to guard vessel 2. Heat from guard vessel 2 may also radiate outwardly toward concrete silo 8 spaced outwardly therefrom.

Systems for removal of this decay heat vent or otherwise remove the heat from reactor 1 and surround structures to a heat sink such as the environment. One such system may be a reactor vessel auxiliary cooling system (RVACS) as shown in FIG. 1. Heat collector cylinder 5 may be concentrically between guard vessel 2 and silo 8 and define hot air riser 4 between guard vessel 2 and an inner surface of heat collector cylinder 5. Heat collector cylinder 5 may further define cold air downcomer 7 between silo 8 and an outer surface of heat collector cylinder 5. Heat may be transferred from guard vessel 2 to air in hot air riser 4. The inner surface of heat collector cylinder 5 may receive thermal radiation from guard vessel 2, with the heat therefrom being transferred by natural convection into the rising air for upward flow to remove the heat via air outlets 9. Heating of the air in riser 4 by the two surrounding hot surfaces induces natural air draft in the system with atmospheric air entering through air inlets 6 above ground level. The air from inlets 6 is ducted to cold air downcomer 7, then to the bottom of concrete silo 8, where it turns and enters hot air riser 4. The hot air is ducted to air outlets 9 above ground level. Similar, related passive reactor coolant systems are described in U.S. Pat. No. 5,190,720 to Hunsbedt et al., issued Mar. 2, 1993, and U.S. Pat. No. 8,873,697 to Horie et al., issued Oct. 28, 2014, all of which are incorporated herein by reference in their entireties.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include systems to flood fillable areas around nuclear reactors to sink heat from the same. A containment structure or building, such as a silo underground or rebar concrete dome, can separate the reactor nearly completely from surrounding environment while also containing open space around and/or under the reactor. Example systems include at least one reservoir of coolant connected to the containment that can be opened and/or closed to flood the coolant into the containment up to the reactor. Sizing of the reservoirs, containments, and/or flow paths therebetween may ensure coolant fills up to touch the reactor but does not block other needed flow paths around the reactor, such as an RVACS air flow space. The reactor may include insulation, such as a guard layer or air gap, on the pressure vessel of the reactor to reduce damage or other operational interference caused by extreme temperature differences and heat capacities between the coolant and pressure vessel. For example, using liquid water from a spent fuel pool or in-containment tank to flood the area immediately surrounding the reactor may be negotiated via an air-gapped guard vessel on the pressure vessel to ensure no overly-rapid quenching, steam explosion, temperature expansion/constriction gradient, etc. occurs to the reactor.

Example systems may be installed and operated at any point in plant life. This may allow other safety systems, potentially already existing, to be operated not as last-resort or safety-regulated systems. For example, an RVACS may be outfitted with electrically-powered blowers or cut-offs for improved performance, or surrounding rock pile for added security, without risk of performance degradation in the RVACS ultimately threatening loss of decay heat sinking. Methods of installation may provide a coolant source and connect the same to the containment, such as an external tank of natural body of water, through a pipe or line running underground, or with an internal tank like a holding annulus inside a perimeter of the containment structure that floods the same. The sources may be supplied or filled with volumes of coolant sufficient to fill spaces around the reactor with heat-sinking coolant, while not over-flooding or blocking other cooling components.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is a profile schematic of a related art reactor vessel auxiliary cooling system (RVACS).

FIG. 2 is a profile schematic of an example embodiment flooding system in use with an RVACS-equipped reactor.

FIG. 3 is a profile schematic of the example embodiment flooding system in use inside a containment silo of a reactor.

FIG. 4 is a detail cross-section of a guard vessel useable in example embodiment systems.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

Proportions, sizes, and shapes shown in the figures are examples for illustration. While they reflect features of some example embodiments, other relationships and magnitudes of dimensions are included in these examples. As used herein, “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature and more likely oriented with gravity.

The inventors have recognized that existing containment buildings and reactor housing structures are conventionally kept isolated and dry, with no free-standing coolant therein that might contact the reactor. Direct contact with a reactor or nearby structure with a higher heat-sinking coolant, such as liquid water, may represent a risk of too great a temperature change or variation within a pressure vessel like those forming many types of reactors. Other safety systems are instead used to inject coolant directly into the reactor, and/or provide gaseous or air ventilation about the reactor, such as with an RVACS with lower heat-sinking coolant. Because these may be safety-related systems to dissipate decay heat, they may need to be completely passive and unencumbered, such that powered fans or dampers, or blocking shields that might protect the same from external threats, cannot be used where they may interfere with such heat-sinking in transient scenarios. For an RVACS, this further counsels for a dry containment with no other liquid coolant around a reactor that might block airflow around the same. The inventors have thus recognized multiple problems in otherwise sinking decay heat from a reactor while simultaneously improving safety and operations in existing coolant systems, especially in introducing a further coolant into containment that might directly sink heat from a reactor exterior. To overcome these newly-recognized problems as well as others, the inventors have developed example embodiments and methods described below to address these and other problems recognized by the inventors with unique solutions enabled by example embodiments.

The present invention is systems for introducing a coolant around a nuclear reactor exterior, and methods of installing and operating the same as well as relieving and allowing reconfiguration of additional safety systems with the same. In contrast to the present invention, the few example embodiments and example methods discussed below illustrate just a subset of the variety of different configurations that can be used as and/or in connection with the present invention.

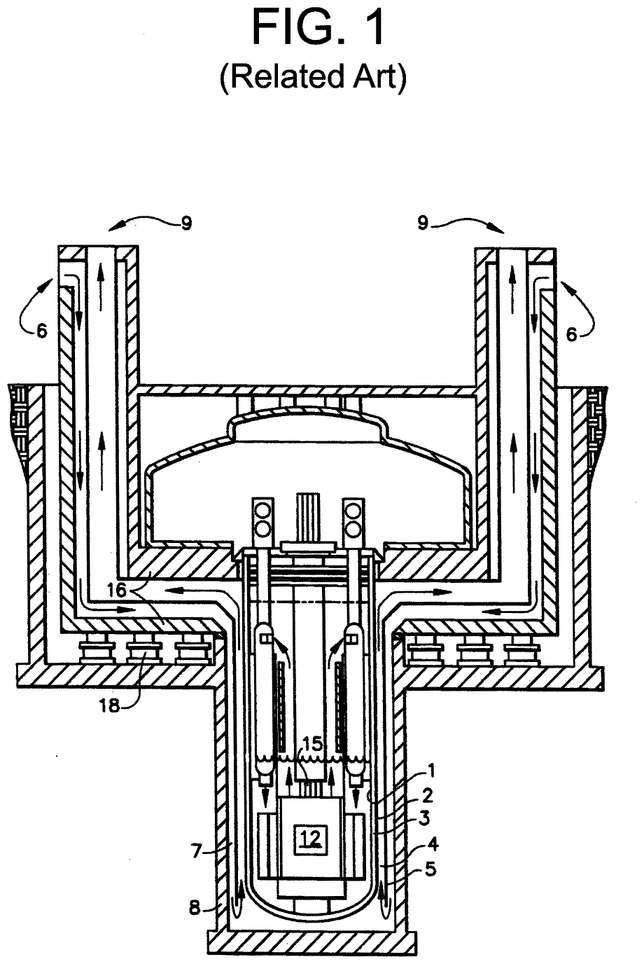

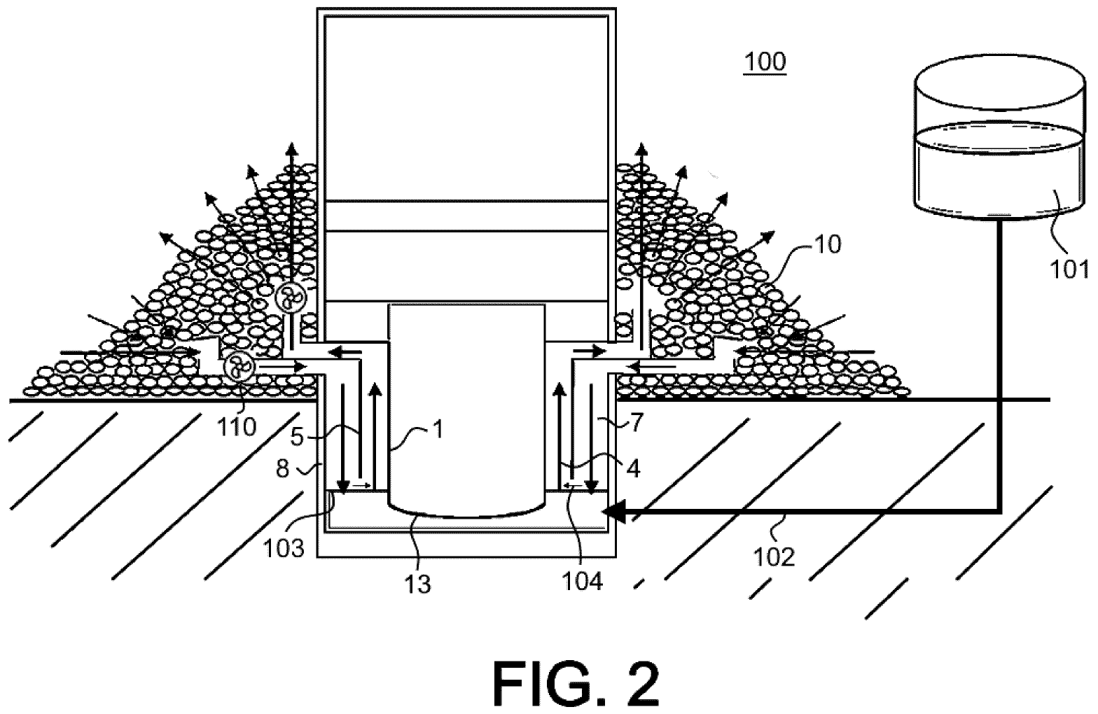

FIG. 2 is a schematic illustration of an example embodiment flooding system 100 useable to cool a nuclear reactor inside a containment structure, such as a nuclear reactor silo 8 housing reactor 1 and a passive coolant system such as an RVACS of FIG. 1. Example embodiment system 100 includes coolant source 101 housing a large amount of heat sink coolant, such as liquid water. Coolant source 101 is connected by flow path 102 to provide the coolant to directly absorb heat from the reactor. For example, flow path 102 may open into an open, fillable area in silo 8 about bottom 13 of reactor 1. Coolant may flow from source 101, through flow path 102 into silo 8 and directly contact an outside of reactor 1, sinking heat from the same without injection into fuel or other reactor internals.

Coolant source 101 may be an external tank as shown in FIG. 2 housing thousands of gallons of liquid water or more. Such an external tank may be outside silo 8 and/or any other containment structure, to allow external filing, purification, refilling, etc. within involvement with containment. For example, source 101 may be an internal or external coolant pool, natural body of water, spent fuel pool, etc. Source 101 may further be several sources, such as a nearby river, onsite holding tank, and spent fuel pool all connected to flow into silo 8 upon opening of flow path 102.

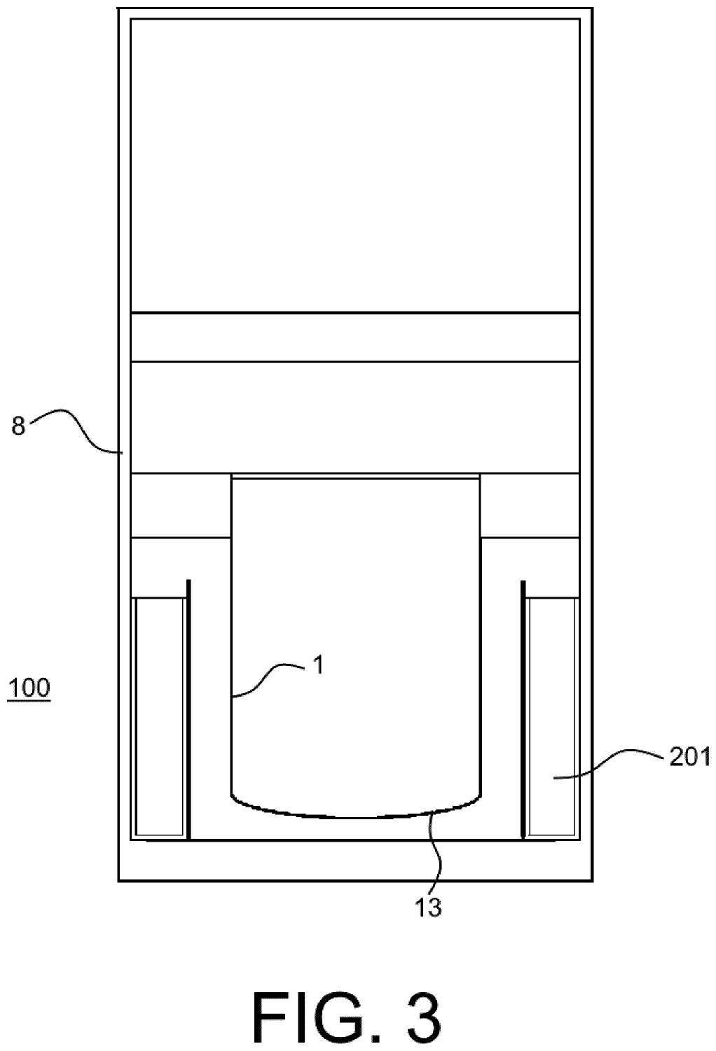

Or, for example, as shown in FIG. 3, source 101 may be annular tank 201 entirely within a containment such as silo 8. Annular tank 201 may extend about a partial or entire outer perimeter of the containment, from a floor or other height to a substantial elevation around reactor 1. Annular tank 201 may flow directly into an area below reactor 13, with a minimal or nonexistent flow path 102, such as valving under operator manual control or plant system automated actuation, a rupture disk, and/or a frangible seam in tank 201 configured to fail open at threshold temperatures or transient conditions.

FIG. 2 further illustrates rock pile 10, which optionally provides security and access restriction to RVACS entrances about silo 8 or other reactor containment structure. A similar configuration is described in U.S. Pat. No. 11,443,859 to Bass et al., incorporated herein by reference in its entirety. Rock pile 10 may similarly extend around source 101 and flow path 102. Similarly, coolant provided to silo 8 may evaporate or flow out of RVACS, a relief line, or another vent, out of rock pile 10 without becoming blocked or building pressuring in silo 8.

Flow path 102 may open about bottom 13 of reactor 1, allowing coolant from source 101 to flow into and flood silo 8 up to impingement level 103 where the coolant contacts reactor bottom 13. For example, flow path 102 may be piping or another channel running underground to a bottom of silo 8 below ground. Pumps and/or valves on flow path 102 may control a flow of liquid coolant into silo 8. Additionally or alternatively, coolant may flow from source 101 into silo 8 through gravity alone, such as following opening of a valve or rupture disc at a transient threshold or operator action. In this way, coolant source 101 and flow path 102 may passively provide coolant to contact reactor 1 without the need for outside power or operator action or monitoring.

Impingement level 103 of the coolant liquid may be below a lowest point of a divider between hot air riser 4 and cold air downcomer 7 in heat collector cylinder 5. This may preserve an above-liquid passage 104 for air or other coolant less dense than that used in source 101 to pass between riser 4 and downcomer 7. In this way, coolant flow, such as airflow, through cylinder 5 and an RVACS in general may still be possible in example embodiments, and even the use of a heavy liquid coolant may not block flow through an RVACS.

Impingement level 103 may be ensured at levels to preserve passage 104 in any manner, including limiting total volume of source 101 to that less than a volume of liquid within silo 8 below passage 104, by positioning source 101 such that the coolant level in source 101 is at passage 104 and preserves the same when flowed into silo 8, by limiting flow rates into silo 8 to those expected to match evaporation, vaporization, and/or outflow of the coolant once in contact with bottom 13 of reactor 1, such as through valves, pump speeds, dimensions of flow path 102, etc., overflow drains open only at or above level 103, and/or via cut-off triggers that close flow path 102 when coolant level reaches impingement level 103, etc. The volume and levels of coolant necessary to both reach the reactor and not interfere with other in-containment coolant structures can be readily determined from the amount of free volume inside a containment around a reactor, with maintenance and make-up matching expected evaporation, vaporization, leakage, etc. rates.

Contact at lower surface of reactor 13 by the coolant may be direct or indirect, such as through a guard vessel. If the coolant contacts sufficient surface area, even at elevated temperatures a modest amount of coolant may be sufficient to remove decay heat when reactor 1 is scrammed or shut down. For example, 6 gallons per minute of water provided from source 101 and evaporated by decay heat from reactor 1 may represent a thermal megawatt of heat sinking provided to the reactor. Needing to sink decay heat, which may be less than 7% of a reactor's rated thermal power at shutdown and exponentially reducing to 1.5% of the same after an hour, may thus require a relatively small amount of water provided, such that a spent fuel pool or other flexible source may be used for source 101.

Because the flooding and coolant contact provided in example embodiment system 100 may provide relatively large amounts of passive decay heat sinking, potentially for days or weeks post-shutdown, the RVACS and any other reactor safety system may not need to be relied on for safety purposes. For example, powered ventilation system 110 in RVACS riser 4 or downcomer 7 that actively drive airflow may not be useable or relied upon as safety systems because of their active power requirement. With example embodiment system 100 in place, fans and/or dampers in ventilation system 110 may be used to enhance air flow through the RVACS in conjunction with system 100 or at any other desired time. Similarly, RVACS could be passively sealed or otherwise taken out of service to enhance plant thermodynamics because system 100 may be relied upon to provide safety cooling. For example, damper systems for closing an RVACS disclosed in U.S. Pat. No. 10,937,557 to Sineath et al, incorporated by reference herein in its entirety, may be used without any risk of loss of RVACS function when needed as a safety system of last resort.

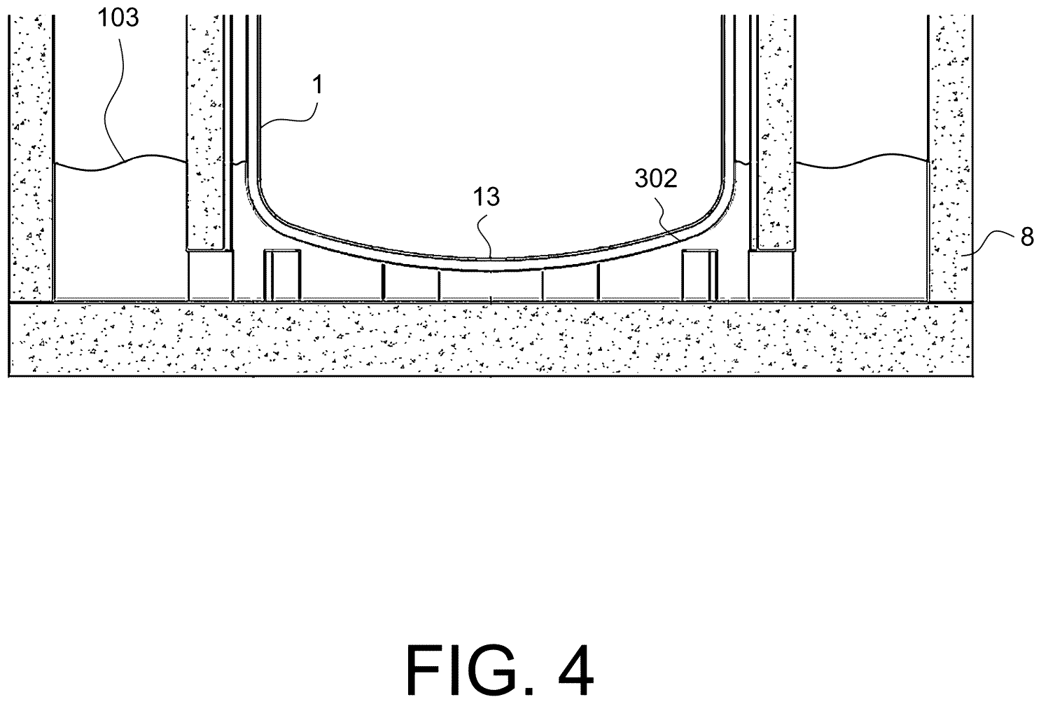

FIG. 4 is a detail illustration of insulated guard vessel 302 of reactor 1 configured to directly contact a higher heat-sinking coolant in example systems while protecting the pressure vessel of reactor 1 from too rapid of a quench. For example, using 15-20° C. water as the flood coolant about bottom 13 of reactor 1 at approximately 190° C., insulated guard vessel 302 may prevent the pressure vessel walls at bottom 13 of reactor 1 from cooling more than approximately 0.2-1° C. per second, such as a 0.67° C. per second limit on cooling rate of the vessel wall under these operating conditions. An intermediate boundary provided by guard vessel 302 may reduce surface temperature differential thus eliminating any material concerns from too rapid of a quench or extreme temperature gradient in the pressure vessel wall or from steam explosions or thin-film insulation formation from overheating the coolant. Such insulation may be provided through any material, including an inert air gap between an outer pressure vessel surface and guard vessel 302. The pressure vessel of reactor 1 may be completely surrounded by guard vessel 302 up to a support flange at a top of silo 8, with securing contacts between the vessels and at penetrations, or guard vessel 302 may be only at selective positionings, such as only those elevations or locations expected to be directly impinged by the coolant in example systems. In this way, a flooding coolant in example system 100 may directly contact guard vessel 302, remove sufficient decay heat to fully cool shutdown reactor 1, and boil off or flow through the RVACS or other relief line, without risk of too rapidly quenching the pressure vessel of reactor 1 or needing any other safety system.

Example embodiment flooding system 100 can be installed at plant fabrication or at any point at plant life. For example, system 100 may be installed in an existing containment such as silo 8, potentially with an RVACS system, or added to the same during plant construction by installing source 101 within or near the containment, potentially with flow path 102. For example, an existing spent fuel pool as source 101 may be connected to an opening in containment with proper controls and valving to allow water in the pool to reach elevations of at least bottom 13 of reactor 1. Similarly, insulated guard vessel 302 may be installed on a bare reactor 1 at fabrication or installation, or may replace an existing guard vessel or be fabricated from an existing guard by adding sufficient insulation to allow direct coolant contact without damage to the reactor.

Once installed, example embodiment system 100 may be activated by allowing coolant to flow from source 101 into the containment and up to an elevation of reactor 1. This may be achieved passively by simply opening a flow path like a valve and allowing the coolant to drain into the containment under gravity. As coolant directly contacts a pressure vessel and/or guard vessel of reactor 1, it sinks heat from the same, potentially all decay heat from the same. The evaporated, vaporized, or boiled coolant may then exit, such as through an RVACS or other relief line. This flooding may be performed during a transient event, at installation, during a testing event, such as during a maintenance outage, and/or at any other time of desired cooling. While example embodiment system 100 is installed, other systems may be used in a non-safety and non-passive manner. For example, active fans, damper structures, and other uses of an RVACS to enhance its operation may be used when system 100 is installed.

Example embodiment system 100 may be fabricated of resilient materials that are compatible with a nuclear reactor environment without substantially changing in physical properties, such as becoming substantially radioactive, melting, embrittlement, and/or retaining/adsorbing radioactive particulates. For example, several known structural materials, including austenitic stainless steels 304 or 316, XM-19, zirconium alloys, nickel alloys, Alloy 600, etc. may be chosen for any element of components of example embodiment systems, including annular tanks and guard vessel in closer proximity to a reactor. Joining structures and directly-touching elements may be chosen of different and compatible materials to prevent fouling.

Example embodiments and methods thus being described, it will be appreciated by one skilled in the art that example embodiments may be varied and substituted through routine experimentation while still falling within the scope of the following claims. For example, while some example embodiments are shown in use in combination with reactors having an RVACS, other reactor containments and plants can be used simply through proper positioning and sizing of example embodiments—and fall within the scope of the claims. Such variations are not to be regarded as departure from the scope of these claims.

What is claimed is:

1. A flooding system for removing decay heat from a nuclear power plant, the flooding system comprising:
a containment building of the nuclear power plant housing a nuclear reactor having a bottom at a first elevation in the containment building;
a coolant source; and
a flow path from the coolant source to an open space of the containment building outside the reactor, wherein the flow path is configured to selectively allow coolant in the coolant source to flow into the open space, and wherein the coolant source has a volume greater than a volume of coolant required to fill the open space up to the first elevation so as to contact the reactor.

2. The system of claim 1, wherein the containment building further includes a divided flow channel having a coolant downcomer opening at a coolant source inlet and a coolant riser exhausting outside the containment building, wherein the coolant downcomer and coolant riser are in fluid communication at a bottom of the divided flow channel, wherein the volume of the coolant source is less than a volume of coolant required to fill the open space to completely block flow between the coolant downcomer and riser.

3. The system of claim 2, wherein the reactor includes a guard vessel completely surrounding a pressure vessel of the reactor where the coolant contacts the reactor, wherein the guard vessel insulates the pressure vessel from a damaging temperature gradient caused by the coolant contacting the reactor.

4. The system of claim 3, wherein the coolant is liquid water, and wherein the guard vessel prevents temperature change in the pressure vessel above 0.67° C. per second when the pressure vessel is at approximately 190° C.

5. The system of claim 2, wherein the divided flow channel includes at least one of a powered fan and a powered damper, the system further comprising:
a rock pile surrounding inlets and exhausts of the divided flow channel, and wherein the coolant is configured to flow out of the divided coolant channel and rock pile after sinking heat from the reactor.

6. The system of claim 1, wherein the coolant source is a spent fuel pool of the nuclear power plant.

7. The system of claim 1, wherein the coolant source is an annulus lining a perimeter of the containment building.

8. The system of claim 1, wherein the flow path and coolant source are configured to provide liquid water into the open space at a rate of at least 6 gallons per minute.

9. The system of claim 2, wherein the flow path and coolant source are configured to provide the liquid water at the rate passively under gravity alone, and wherein the flow path extends underground to the containment building underground.

10. A flooding system for removing decay heat from a nuclear power plant, the flooding system comprising:
a coolant source configured to provide a liquid coolant that contacts a bottom of a nuclear reactor; and
a guard vessel configured to surround the bottom of the nuclear reactor, wherein the guard vessel provides a thermal insulation directly to an outer surface of a pressure vessel of the nuclear reactor, and wherein the guard vessel prevents temperature change in the pressure vessel above 0.67° C. per second when the pressure vessel is at approximately 190° C.

11. The system of claim 10, wherein the liquid coolant is liquid water, the system further comprising:
a containment structure housing the reactor with guard vessel, wherein the containment structure extends underground and is configured to fill with the coolant from the coolant source up to at least the bottom of the nuclear reactor.

12. The system of claim 11, wherein the coolant source is at least one of a spent fuel pool of the nuclear power plant and an annulus lining a perimeter of the containment structure.

13. The system of claim 11, wherein the containment structure includes a reactor vessel auxiliary cooling system (RVACS) having a coolant downcomer opening at a coolant source inlet and a coolant riser exhausting outside the containment structure, wherein the coolant downcomer and coolant riser are in fluid communication at a bottom of the divided flow channel, wherein the coolant source is configured to flood the containment structure to a level below where the coolant downcomer and coolant riser are in fluid communication.

14. The system of claim 11, wherein the RVACS includes at least one of a powered fan and a powered damper, the system further comprising:
a rock pile surrounding inlets and exhausts of the divided flow channel, and wherein the coolant is configured to flow out of the divided coolant channel and rock pile after sinking heat from the reactor.

15. The system of claim 10, wherein the insulation is provided may an inert gas between the pressure vessel and the guard vessel.

16. A method of configuring nuclear power plant having a nuclear reactor housed in a containment structure with a bottom of the nuclear reactor at an elevation within the containment structure to supplement safety systems of the nuclear plant, the method comprising:
connecting a coolant source to an open space of the containment structure outside the reactor such that coolant is selectively flowable from the coolant source into the open space, and wherein the coolant source has a volume greater than a volume of the coolant required to fill the open space up to the elevation of the reactor bottom.

17. The method of claim 16, further comprising:
installing a guard vessel surrounding a reactor pressure vessel of the reactor, wherein the guard vessel provides a thermal insulation directly to an outer surface of a pressure vessel and vessel prevents temperature change in the pressure vessel above 0.67° C. per second when the pressure vessel is at approximately 190° C. and the reactor is immersed in the coolant.

18. The method of claim 16, wherein the coolant is liquid water, and wherein the coolant source is at least one of a spent fuel pool and an annular tank lining a perimeter of the containment structure.

19. The method of claim 16, wherein the containment structure includes a reactor vessel auxiliary cooling system (RVACS) having a coolant downcomer opening at a coolant source inlet and a coolant riser exhausting outside the containment structure, wherein the coolant downcomer and coolant riser are in fluid communication at a bottom of the divided flow channel, wherein the volume of the coolant source is less than a volume of coolant that when filling the containment structure reaches a level to block the coolant downcomer and coolant riser from fluid communication inside the containment structure.

20. The method of claim 19, further comprising:
operating a powered ventilation system in the RVACS while the reactor is commercially operating to generate electricity, wherein the RVACS is surrounded by a rock pile blocking an entrance and exhaust of the RVACS but allowing fluid flow into and out of the RVACS.
